(19) United States
(12) Patent Application Publication
(10) Pub. No.: US 2025/0056175 A1
(43) Pub. Date: Feb. 13, 2025

(54) APPARATUS AND METHOD FOR SCALING OF DUCKING GAINS FOR SPATIAL, IMMERSIVE, SINGLE- OR MULTI-CHANNEL REPRODUCTION LAYOUTS

(71) Applicant: Fraunhofer-Gesellschaft zur Förderung der angewandten Forschung e.V., München (DE)

(72) Inventors: Alessandro TRAVAGLINI, Erlangen (DE); Jouni PAULUS, Erlangen (DE); Lukas LAMPRECHT, Erlangen (DE); Jakob STRUVE, Erlangen (DE); Matteo TORCOLI, Erlangen (DE)

(73) Assignee: Fraunhofer-Gesellschaft zur Förderung der angewandten Forschung e.V., München (DE)

(21) Appl. No.: 18/928,151

(22) Filed: Oct. 27, 2024

Related U.S. Application Data
(63) Continuation of application No. PCT/EP2022/061260, filed on Apr. 27, 2022.

(51) Int. Cl. H04S 5/00

(52) U.S. Cl. CPC H04S 5/00

(57) ABSTRACT

An apparatus for generating one or more audio output channels from one or more audio signals is provided. The apparatus comprises a gain determiner configured to generate or to receive gain information, wherein the gain information indicates for each audio signal of at least one audio signal of the one or more audio signals how to attenuate or how to amplify said audio signal depending on a position associated with said audio signal and a reference position. Moreover, the apparatus comprises a signal generator configured to generate the one or more audio output channels from the one or more audio signals by attenuating or amplifying at least one of the one or more audio signals depending on the gain information.

### CROSS-REFERENCE TO RELATED APPLICATIONS

This application is a continuation of copending International Application No. PCT/EP2022/061260, filed Apr. 27, 2022, which is incorporated herein by reference in its entirety.

The present invention relates to audio ducking, and, in particular, to an apparatus and to a method for scaling of ducking gains for spatial, immersive, single or multi-channel reproduction layouts.

### BACKGROUND OF THE INVENTION

In a lot of systems, object mixing can be controlled by defining a ducking sequence that applies a time-varying (attenuation) gain on specific audio objects. An example is attenuating the background when foreground speech is active. By default, all channels of a multichannel background signal are attenuated equally. This creates a perceived loss of sound pressure (a hole) in spatial regions where the foreground signal is not present, e.g., behind the listener. The problem is more prominent in immersive loudspeaker layouts.

Ducking is an audio production technique used in mixing two or more audio component signals using signal-dependent, time-varying gains. In the example case of two component signals, e.g., a dialogue or speech signal and a background signal, the background signal is attenuated by some amount when the dialogue signal is active. This accomplishes that the overall level of the mixture signal remains roughly constant, as opposed to the situation in which the dialogue signal is mixed on top of the constant-level background signal and the resulting mixture has a higher overall level. Moreover, by attenuating the background signal e.g. applying time-varying gains, the dialogue becomes more intelligible, and the listening effort is reduced. Another example of ducking is when a DJ or radio moderator talks on top of the music, and the level of the music is reduced (“ducked”) during the talk.

In channel-based audio transport, the component signals are mixed during production and only this ready full mixture is transported.

In object-based audio (OBA), the individual component audio signals, or sub-mixes thereof, and the mixing instructions are transmitted separately, and the final mixing takes place in the decoding and rendering device, possibly accounting for additional end-user interactivity actions.

One of these mixing instructions is the time-varying ducking gain. In other words, the ducking can take place already during the production (destructive process) or the ducking instructions are transported along the component audio and the ducking takes place in the rendering phase (non-destructing process). These alternatives have slightly different bounding conditions, but aim at accomplishing the same result for the end-user listening experience.

In the following, the term dialogue, foreground, or primary signal may, e.g., be interpreted to correspond to the signal whose presence is controlling the ducking.

The term background or secondary signal may, e.g., be interpreted to correspond to the signal on which the ducking is applied. These signals are denoted with fᵢ(t) for the foreground signal and bᵢ(t) for the background signal, wherein i∈[1,N] is the channel index over the total of N channels, and t is the time index. If the two signals have a different number of channels, the missing channels may, e.g., be padded with zeros, or a format conversion processing may, e.g., be employed.

Some of the existing methods for performing the ducking rely on creating a single time-varying gain that is applied on all the background signal's channels. Considering the OBA-transport, this is easily motivated by efficiency as only a single gain signal is transported instead of having a dedicated gain signal for each audio signal. In state-of-the-art ducking applications or audio mixing tools the background signal is attenuated according to a single ducking gain.

Speaker layouts that implement immersive playback may, e.g., be considered to have more than 2 loudspeaker channels to be immersive (e.g., anything above stereo). A major purpose of immersive playback layouts is to place the loudspeakers into multiple physical positions allowing reproducing the 3D-direction of sound sources more accurately. Examples of common immersive layouts are 5.1 (front left, front right, center, surround left, surround right, LFE), or, for example, a 22.2 layout. Even though the increased number of loudspeakers allows for much artistic freedom in the design of an audio scene, the dialogue content is often placed at the front of the audio scene and mainly, if not exclusively, reproduced by the center loudspeaker, while the other channels provide more support for the immersive background signal.

A solution currently existing for the ducking in immersive layouts is that a common ducking gain is designed such that it is aesthetically acceptable when equally applied on all channels. This is usually a compromise between the depth of the ducking needed for making the foreground signal more prominent and between the unnecessary ducking of channels where this is not needed. Additional per-channel scaling values may, e.g., be set manually, however, such manual settings are extremely laborious to design and still they do not guarantee optimality.

### SUMMARY

According to an embodiment, an apparatus for generating one or more audio output channels from one or more audio signals may have: a gain determiner configured to generate or to receive gain information, wherein the gain information indicates for each audio signal of at least one audio signal of the one or more audio signals how to attenuate or how to amplify said audio signal depending on a position associated with said audio signal and a reference position, and a signal generator configured to generate the one or more audio output channels from the one or more audio signals by attenuating or amplifying the at least one audio signal depending on the gain information.

According to another embodiment, an apparatus for encoding one or more audio signals within a bitstream may have: a gain determiner configured to generate gain information, wherein the gain information indicates for each audio signal of at least one audio signal of the one or more audio signals how to attenuate or how to amplify said audio signal depending on a position associated with said audio signal and a reference position, and a bitstream generator configured to encode the one or more audio signals within a bitstream, wherein the bitstream generator is configured to generate the bitstream such that the bitstream includes the gain information.

According to another embodiment, an apparatus for obtaining gain information may have: a user interface including input means, which enable a user to enter input information, wherein the input information includes the gain information or wherein the apparatus is configured to derive the gain information from the input information, wherein the gain information indicates for each audio signal of at least one audio signal of one or more audio signals how to attenuate or how to amplify said audio signal depending on a position associated with said audio signal and a reference position.

According to another embodiment, a method for generating one or more audio output channels from one or more audio signals may have the steps of: generating or receiving gain information, wherein the gain information indicates for each audio signal of at least one audio signal of the one or more audio signals how to attenuate or how to amplify said audio signal depending on a position associated with said audio signal and a reference position, and generating the one or more audio output channels from the one or more audio signals by attenuating or amplifying the at least one audio signal depending on the gain information.

According to another embodiment, a method for encoding one or more audio signals within a bitstream may have the steps of: generating gain information, wherein the gain information indicates for each audio signal of at least one audio signal of the one or more audio signals how to attenuate or how to amplify said audio signal depending on a position associated with said audio signal and a reference position, and encoding the one or more audio signals within a bitstream, wherein the bitstream is generated such that the bitstream includes the gain information.

According to another embodiment, a method for obtaining gain information, may have the steps of: receiving input information via input means of a user interface, wherein the input information includes the gain information or the method may have deriving the gain information from the input information, wherein the gain information indicates for each audio signal of at least one audio signal of the one or more audio signals how to attenuate or how to amplify said audio signal depending on a position associated with said audio signal and a reference position.

Another embodiment may have a non-transitory digital storage medium having a computer program stored thereon to perform any of the inventive methods when said computer program is run by a computer.

An apparatus for generating one or more audio output channels from one or more audio signals is provided. The apparatus comprises a gain determiner configured to generate or to receive gain information, wherein the gain information indicates for each audio signal of at least one audio signal of the one or more audio signals how to attenuate or how to amplify said audio signal depending on a position associated with said audio signal and a reference position. Moreover, the apparatus comprises a signal generator configured to generate the one or more audio output channels from the one or more audio signals by attenuating or amplifying the at least one audio signal depending on the gain information.

Moreover, an apparatus for encoding one or more audio signals within a bitstream according to an embodiment is provided. The apparatus comprises a gain determiner configured to generate gain information, wherein the gain information indicates for each audio signal of at least one audio signal of the one or more audio signals how to attenuate or how to amplify said audio signal depending on a position associated with said audio signal and a reference position. Furthermore, the apparatus comprises a bitstream generator configured to encode the one or more audio signals within a bitstream, wherein the bitstream generator is configured to generate the bitstream such that the bitstream comprises the gain information.

Furthermore, an apparatus for obtaining gain information according to another embodiment is provided. The apparatus comprises a user interface comprising input means which enable a user to enter input information, wherein the input information comprises the gain information or wherein the apparatus is configured to derive the gain information from the input information, wherein the gain information indicates for each audio signal of at least one audio signal of the one or more audio signals how to attenuate or how to amplify said audio signal depending on a position associated with said audio signal and a reference position.

Moreover, a method for generating one or more audio output channels from one or more audio signals according to a further embodiment is provided. The method comprises:
Generating or receiving gain information, wherein the gain information indicates for each audio signal of at least one audio signal of the one or more audio signals how to attenuate or how to amplify said audio signal depending on a position associated with said audio signal and a reference position. And:
Generating the one or more audio output channels from the one or more audio signals by attenuating or amplifying the at least one audio signal depending on the gain information.

Furthermore, a method for encoding one or more audio signals within a bitstream according to another embodiment is provided. The method comprises:
Generating gain information, wherein the gain information indicates for each audio signal of at least one audio signal of the one or more audio signals how to attenuate or how to amplify said audio signal depending on a position associated with said audio signal and a reference position. And:
Encoding the one or more audio signals within a bitstream, wherein the bitstream is generated such that the bitstream comprises the gain information.

Moreover, a method for obtaining gain information according to a further embodiment is provided. The method comprises:
Receiving input information via input means of a user interface, wherein the input information comprises the gain information or wherein the method comprises deriving the gain information from the input information, wherein the gain information indicates for each audio signal of at least one audio signal of the one or more audio signals how to attenuate or how to amplify said audio signal depending on a position associated with said audio signal and a reference position.

Furthermore, computer programs are provided, wherein each of the computer programs is configured to implement one of the above-described methods when being executed on a computer or signal processor.

According to an embodiment, on a decoder-side, a decoder may, e.g., apply scaled ducking and may, e.g., produce audio output for individual channels, for example, depending on a gain sequence, or, for example, depending on layout information.

In another embodiment, on an encoder-side, an encoder may, e.g., generate scaled coefficients and may, e.g., encode them within a bitstream.

However, embodiments are not limited to be applied only to automatic ducking. Instead, some embodiments may, e.g., be employed for supporting to improve the listening experience generated by manual mixing.

According to a further embodiment, manual audio operations may, e.g., be supported.

Means may, e.g., be provided, for example, for an audio engineer to operate a gain controller of an audio content. Scaling to the input audio content may, e.g., be applied depending on gain and output loudspeakers layout and a scaled output audio content may, e.g., be produced.

Some embodiments provide a solution for scaling ducking depth on per-channel basis depending on the spatial location of the channel and on the single or multichannel layout to which it belongs.

According to embodiments, concepts for designing per-channel modification values for the ducking gain are provided such that the spatial hole is reduced, but the overall perceptual ducking depth remains equal to before the modification, and the overall perceptual ducking depth is comparable in all loudspeaker layouts.

In an embodiment, this may, for example, be accomplished by two steps: Reducing the ducking depth, the further away the channel is from the foreground signal location (per-channel ducking scaling), and adjusting this scaling such that the energy of the ducked signal is approximately the same when applying equal ducking in all channels and when using per-channel ducking values.

According to an embodiment, the provided modification gains may, e.g., be applied in MPEG-H transport via DRC modification parameters, currently already in use.

In an embodiment, the implementation may, e.g., comprise pre-computing the modification gains for the supported loudspeaker layouts and using these as pre-defined constants during content authoring.

According to an embodiment, the provided concepts may, e.g., comprise a production-side tool applicable on offline and real-time automatic mixing tools.

In another embodiment, the provided concepts may, e.g., comprise a production-side tool applicable on manually operated audio mixers or audio processors, plug-ins or standalone software.

In an embodiment, a loudspeaker setup may, for example, comply with international audio multichannel standards. For example, the loudspeakers may, e.g., expected to be placed on the surface of a sphere and the listener may, e.g., be in the center of this sphere and therefore the distance between each loudspeaker and the listener may, e.g., be equal. In another embodiment, if this is not the case, it may, for example, be assumed that the loudspeakers are equalized in level and in travel time in order to achieve the same setup as described before. In other words, even though the distance from the listener may, e.g. be physically different, such an equalization may, e.g., compensate the distortion.

In another embodiment, a loudspeaker setup dedicated to reproduce the background signal only may, for example, comprise just one audio signal located in any point in the space.

### BRIEF DESCRIPTION OF THE DRAWINGS

Embodiments of the present invention will be detailed subsequently referring to the appended drawings, in which:

FIG. 1a illustrates an apparatus for generating one or more audio output channels from one or more audio signals according to an embodiment.

FIG. 1b illustrates an apparatus for encoding one or more audio signals within a bitstream according to an embodiment.

FIG. 1c illustrates an apparatus for obtaining gain information according to another embodiment.

FIG. 2a illustrates an apparatus, where a single ducking gain is applied equally on all channels of the background signal.

FIG. 2b illustrates an apparatus according to an embodiment, where per-channel scaling values are applied on a single ducking gain.

FIG. 3 illustrates an a block diagram of an MPEG-H system according to an embodiment, wherein a gain according to an embodiment is applied.

FIG. 4 illustrates a table comprising a plurality of different source test items of a listening test.

FIG. 5 illustrates a table which illustrates a different weighting that has been applied to the channel groups during a first listening test (listening test, part A).

FIG. 6 illustrates a table with a plurality of loudspeaker configurations that have been employed in a listening test.

FIG. 7 illustrates a table showing the results of the first listening test.

FIG. 8 illustrates a table which illustrates a different weighting that has been applied to the channel groups during a second listening test (listening test, part B).

FIG. 9 illustrates a table showing the results of the second listening test.

FIG. 10 illustrates a loudspeaker layout and gains for a particular computation example for great-circle weighting.

FIG. 11 illustrates a loudspeaker layout and gains for a particular computation example for egg weighting.

FIG. 12 illustrates examples for scaling coefficients for several layouts up to 22.2.

### DETAILED DESCRIPTION OF THE INVENTION

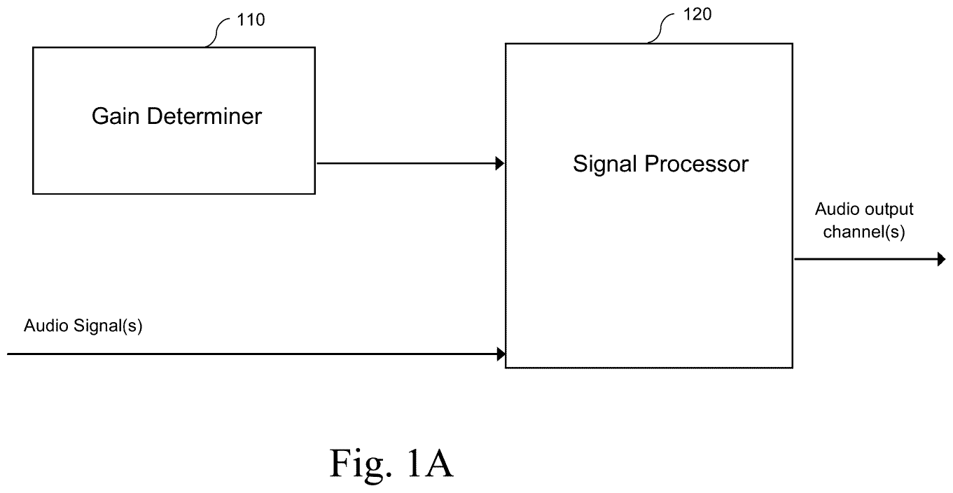

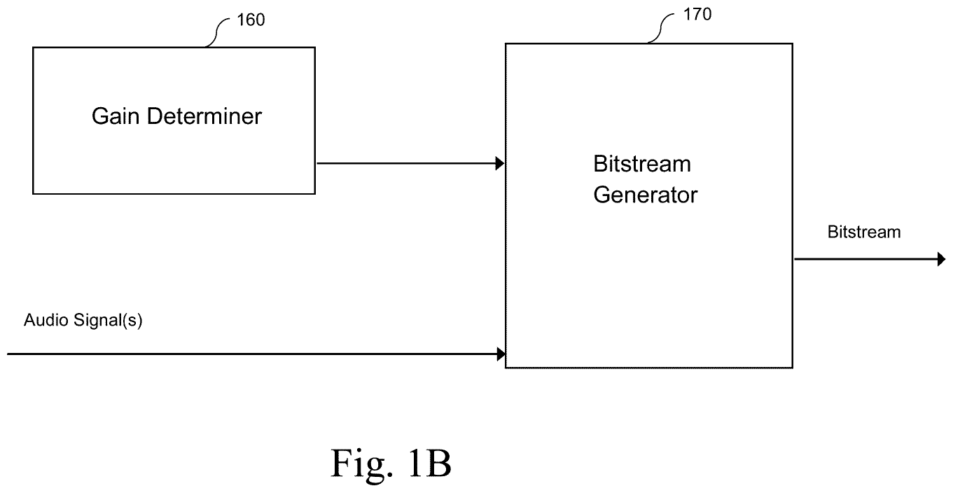

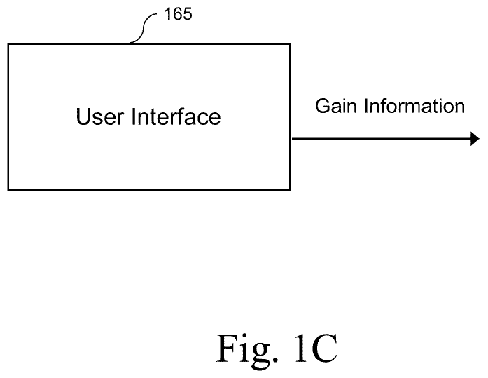

FIG. 1a illustrates an apparatus for generating one or more audio output channels from one or more audio signals according to an embodiment.

The apparatus comprises a gain determiner 110 configured to generate or to receive gain information, wherein the gain information indicates for each audio signal of at least one audio signal of the one or more audio signals how to attenuate or how to amplify said audio signal depending on a position associated with said audio signal and a reference position.

Moreover, the apparatus comprises a signal generator 120 configured to generate the one or more audio output channels from the one or more audio signals by attenuating or amplifying the at least one audio signal depending on the gain information.

In an embodiment, the gain determiner 110 may, e.g., be configured to generate, depending on the position associated with each audio signal of the at least one audio signal and the reference position, the gain information.

According to an embodiment, the gain determiner 110 may, e.g., be configured to receive the gain information from another apparatus.

In an embodiment, the gain determiner 110 may, e.g., be configured to receive the gain information within a bitstream.

According to an embodiment, the signal generator 120 may, e.g., be configured to generate the one or more audio output channels by mixing (for example, by summing, or, for example, by weighted summing) the one or more audio signals after the at least one audio signal of the one or more audio signals have been attenuated or have been amplified.

In an embodiment, the gain information may, e.g., be gain modification information. The gain determiner 110 may, e.g., be configured to receive initial gain information, and is configured to generate modified gain information from the initial gain information using the gain modification information. The signal generator 120 may, e.g., be configured to generate the one or more audio output channels from the one or more audio signals by applying the modified gain information on the at least one audio signal.

According to an embodiment, the apparatus of FIG. 1a may, e.g., comprise a signal decoder, e.g., an MPEG decoder, for example, an MPEG-D decoder, or, for example, an MPEG-H decoder, or, for example, an MPEG-I decoder.

FIG. 1b illustrates an apparatus for encoding one or more audio signals within a bitstream according to an embodiment.

The apparatus comprises a gain determiner 160 configured to generate gain information, wherein the gain information indicates for each audio signal of at least one audio signal of the one or more audio signals how to attenuate or how to amplify said audio signal depending on a position associated with said audio signal and a reference position.

Furthermore, the apparatus comprises a bitstream generator 170 configured to encode the one or more audio signals within a bitstream, wherein the bitstream generator 170 is configured to generate the bitstream such that the bitstream comprises the gain information.

FIG. 1c illustrates an apparatus for obtaining gain information according to another embodiment.

The apparatus comprises a user interface 165 comprising input means which enable a user to enter input information, wherein the input information comprises the gain information or wherein the apparatus is configured to derive the gain information from the input information, wherein the gain information indicates for each audio signal of at least one audio signal of the one or more audio signals how to attenuate or how to amplify said audio signal depending on a position associated with said audio signal and a reference position.

According to an embodiment, the apparatus may, e.g., further comprise a bitstream generator configured to encode the one or more audio signals within a bitstream, wherein the bitstream generator is configured to generate the bitstream such that the bitstream comprises the gain information.

In another embodiment, the apparatus may, e.g., further comprise a signal generator configured to generate one or more audio output channels from the one or more audio signals by attenuating or amplifying the at least one audio signal depending on the gain information.

In an embodiment, the reference position may, e.g., be a physical or a virtual position of a loudspeaker in an environment.

According to an embodiment, the reference position may, e.g., be associated with an audio signal of the one or more audio signals.

In an embodiment, the apparatus of FIG. 1b may, e.g., comprise a signal encoder, e.g., an MPEG encoder, for example, an MPEG-D encoder, or, for example, an MPEG-H encoder, or, for example, an MPEG-I encoder.

According to an embodiment, the reference position may, e.g., be an actual replay position or an assumed replay position of a loudspeaker that is to replay an audio signal of the one or more audio signals or that is to replay an audio signal derived from said audio signal. For each of the at least one audio signal, the position associated with said audio signal may, e.g., be an actual replay position or an assumed replay position of a loudspeaker that is to replay said audio signal or that is to replay an audio signal derived from said audio signal. Or, for example, the position associated with an audio signal of the at least one audio signal and/or the reference position, may, e.g., be any physical or virtual point in the 3D space around the listener.

In an embodiment, the gain information may, e.g., indicate for each audio signal of at least one audio signal of the one or more audio signals how to attenuate or how to amplify said audio signal depending on a distance between the position associated with said audio signal and the reference position.

According to an embodiment, the gain information may, e.g., indicate for at least one of the at least one audio signal that said one of the audio signals shall be attenuated less or shall be amplified more compared to another one of the at least one audio signal, if a first distance between the position associated with said one of the at least one audio signal and the reference position is greater than a second distance between the position associated with said other one of the at least one audio signal and the reference position.

In an embodiment, the one or more audio signals may, e.g., be two or more audio signals, and the at least one audio signal may, e.g., be at least two audio signals.

According to an embodiment, the gain information may, e.g., individually indicate for each audio signal of the at least two audio signals how to attenuate or how to amplify said audio signal.

In an embodiment, the gain information may, e.g., individually indicate for each audio signal of the at least two audio signals how to attenuate or how to amplify said audio signal depending on the position associated with said audio signal and the reference position.

According to an embodiment, the gain information may, e.g., individually indicate for each audio signal of the at least two audio signals how to attenuate or how to amplify said audio signal depending on the distance between the position associated with said audio signal and the reference position.

According to an embodiment, the gain determiner 110, 160 may, e.g., be configured to determine the gain information such that the gain information, for example, indicates gain information for each audio signal of the at least one audio signal, and such that, for example, a sum of an energy of each of the at least one audio signal after attenuation or amplification corresponds or is estimated to correspond to a reference energy or is proportional or is estimated to be proportional to the reference energy.

In an embodiment, the gain determiner 110, 160 may, e.g., be configured to calculate or estimate the reference energy as an energy of the at least one audio signal after being attenuated or amplified, wherein each of the at least one audio signal has been attenuated or amplified with a global gain or with a scaled global gain being the global gain scaled with a scalar value. The gain determiner 110, 160 may, e.g., be configured to calculate or estimate the total energy of the at least one audio signal as an energy of the at least one audio signal after being attenuated or amplified with a per-channel gain, being an individual gain for each of the at least one audio signal.

According to an embodiment, the gain determiner 110, 160 may, e.g., be configured to determine the gain such that a total energy of the at least one audio signal after attenuation or amplification corresponds or is estimated to correspond to a reference energy or is proportional or is estimated to be proportional to the reference energy by employing a loss function.

In an embodiment, the loss function may, e.g., be defined depending on:

$$l ( s ) = {\sum }_{t = T 1}^{T 2} {\vert \frac{p \cdot {e}_{ref} ( t )}{{e}_{scaled} ( t )} - 1 \vert}^{a}$$

wherein l(s) is the loss function, wherein p indicates a real number being different from 0, wherein t indicates a time index being time index T1 or being time index T2 or being a time index between T1 and T2, wherein e_{ref}(t) indicates the total energy, wherein e_{ref}(t) indicates the reference energy and wherein a is a real number. s may, e.g., be a real number. For example, s may, e.g., be a number described with respect to equation (9) and/or equation (11).

According to an embodiment, the gain information indicates for each audio signal of the at least one audio signal how to attenuate or how to amplify said audio signal depending on an angle between the position associated with said audio signal and the reference position.

In an embodiment, the gain information comprises a per-channel gain (for example, decibel gain) for each of the at least one audio signal. To generate the one or more audio output channels, the signal generator 120 may, e.g., be configured to apply, for each one of the at least one audio signal, the per-channel gain for said one of the at least one audio signal on said one of the at least one audio signal.

According to an embodiment, the position associated with each of the at least one audio signal and the reference position may, e.g., be located on a circle or on an ellipsoid or on a three-dimensional area surrounding the listener.

In an embodiment, the gain information indicates for each audio signal of the at least one audio signal how to attenuate or how to amplify said audio signal depending on a distance, e.g., a great-circle distance or another kind of distance, between the position associated with said audio signal and the reference position.

According to an embodiment, the gain determiner 110, 160 may, e.g., be configured to generate and to quantize the gain information. Or, the gain determiner 110, 160 may, e.g., be configured to receive the gain information as quantized information.

Regarding certain terminologies, an audio signal (or just signal) may, e.g., be a representation of sound waves. An audio channel (or just channel) may, e.g., be an audio signal as reproduced by a physical or virtual loudspeaker, the loudspeaker being located at a specific virtual or physical point in the space. Channel-based audio may, e.g., be a format which may, e.g., carry only information about the audio signal essence and which is supposed to be reproduced without needing rendering by the corresponding one or more loudspeakers. Object-based audio may, e.g., be a format which carries both the audio signal essence and the metadata needed to render it and to be reproduced by one or more loudspeakers. Spatial audio may, e.g., be a sound signal arriving to the listener from any location in the three-dimensional space. Multi-channel audio (or multichannel audio) may, e.g., be an audio content comprising two or more individual audio signals. Immersive audio (or immersive sound) may, e.g., be an audio content which, when reproduced appropriately, immerges the listener into a three-dimensional sound field. Per-channel processing may, e.g., be an operation which is applied individually to each of the audio channel of a multi-channel or immersive content. A foreground signal (or just foreground) may, e.g., be an audio content or a sound source supposed to be of primary importance for the carriage of the main information or narration of the storytelling. A background signal (or just background) may, e.g., be an audio content or a sound source of secondary importance compared to the foreground signal and whose level is supposed to be attenuated if its amount would potentially reduce the intelligibility of the foreground signal.

In the following, some background considerations are described.

g(t) in Equation (1) denotes a single global time-varying ducking gain, which may, e.g., be a value in a decibel-domain, meaning that any attenuation factor may, e.g., be represented by a negative value, the relationship between the linear gain gₜᵢₙ(t) and the decibel-domain value g(t) is

$$g ( t ) = 20 {log}_{10} {g}_{lin} ( t ) . \qquad ( 1 )$$

g(t) is in dB (g(t) is in the decibel-domain).

$${g}_{lin} ( t ) = {10}^{g ( t ) / 20} . \qquad ( 2 )$$

gₜᵢₙ(t) indicates g(t) in a linear domain.

The output from the mixing with ducking gains is:

$${y}_{i} ( t ) = {f}_{i} ( t ) + {b}_{i} ( t ) {g}_{lin} ( t ) . \qquad ( 3 )$$

Equation (3) describes the non-scaled ducking where f is the foreground signal and b is the background signal; i is the channel index.

Even though, the single ducking gain is economical from computation and transport aspects, it is sub-optimal from an aesthetic perspective of the resulting audio scene. An example illustrating this is to consider an immersive, heavy rain scene and dialogue in or near the front center. Attenuating all signals of the background channels with the same ducking gain gives a balanced dialogue-to-background ratio and the overall mixture sounds quite good but only until the listeners move their heads, even if just by the smallest amount.

In fact, the head movement allows the auditory system to solve the front/back assignment of the sound sources. As soon as the background is attenuated during the active dialogue in the front center, the auditory system notices the attenuation of the background sounds arriving from the rear, too. While the attenuation may be needed for the overall dialogue-to-background ratio, the ducking of the signals of the rear channels results in a “having a hole” experience since the dialogue signal is not there to compensate for the energy loss generated by the ducking. The denser the background audio in the rear is, the more prominent the hole becomes.

In the following, particular embodiments of the present invention are described in detail.

According to some embodiments, the problem of the hole appearing in the unmasked regions of the audio scene (and, more generically, in any channel but the front-center) is resolved.

In some embodiments, the amount of ducking of signals that are reproduced in channels further away from the location of the foreground may, e.g., be reduced. In an extreme case, one could disable ducking completely for the furthest channels.

According to some embodiments, this may, e.g., be implemented with a per-channel scaling factor cᵢ that may, e.g., be applied on the linear ducking gains to obtain per-channel linear gains as

$${g}_{lin , i} ( t ) = {c}_{i} {g}_{lin} ( t ) \qquad ( 4 )$$

Or, in an embodiment, the per-channel scaling factor cᵢ may, e.g., be applied on the decibel-scale gains as

$${g}_{i} ( t ) = {c}_{i} g ( t ) . \qquad ( 5 )$$

cᵢ is the scaling coefficient applied to g for each channel

In a particular embodiment, the transport standard of MPEG-D DRC may, e.g., be used, which supports defining per-channel scaling values, that may, according to an embodiment, then be applied on the decibel-scale ducking gains.

In an embodiment, the values for cᵢ may, e.g., be designed manually for the highest overall aesthetic quality. However, in other embodiments, the values for cᵢ may, e.g., be determined automatically. The large number of possible loudspeaker layouts and differing personal tastes are arguments for an automated design.

In an embodiment, a distance between the foreground and the background loudspeakers locations may, e.g., be employed as the basis for the scaling.

Some embodiments are based on the concept that the larger the distance is, the smaller the per-channel scaling cᵢ should be to reduce the ducking depth in those channels.

In a particular embodiment, a distance, e.g., a great-circle distance or another kind of distance, between the foreground and the background loudspeakers locations may, e.g., be employed as the basis for the scaling. The great-circle distance is the shortest distance between two points on the surface of a sphere. It should be noted that the use of the great-circle distance assumes that the sensitivity of the auditory system is equal along all three axes, while in reality, this assumption is definitely not the case. However, the major benefit of the measure is that it is easy to compute in closed form. If an ellipsoid instead of a sphere would be used, there would no longer be a closed form solution, but a computationally much more expensive numerical approximation would be needed. In other words, employing the great-circle distance provides computational efficient results with a suitable quality.

Some embodiments may, for example, use a distance between the two sound sources (foreground and background), and using the great-circle distance represents just one of a plurality of different embodiments for computation.

The great-circle distance between two points p₁=[x₁,y₁, z₁]^{T} and p₂=[x₂,y₂,z₂]^{T} (cartesian coordinates) that both are on the unit sphere centered around [0, 0, 0]T (^{T} indicates transpose, e.g., matrix transpose or, e.g., vector transpose: it is used to indicate that the three scalars should be represented vertically in the equation), and it may, e.g., be assumed that the listener is located in the center of the sphere, e.g., ∥pᵢ∥=1, (magnitude, length of the vector p. It shall be equal 1 because it may, e.g., be assumed that the points are placed on the unit sphere). The great-circle distance may, e.g., be defined to depend on the angle between the two vectors

$$d ( {p}_{1} , {p}_{2} ) = \frac{{cos}^{- 1} 〈 {p}_{1} , {p}_{2} 〉}{π} , \qquad ( 6 )$$

where (pᵢ, pⱼ) indicates the inner product (a matrix computation/vector computation) between the two vectors. The resulting distance value has a minimum when the two points coincide, and has a maximum when the points are on the opposite sides of the sphere.

Now assuming that the main foreground is located at p₀ and the background channel i is located at pᵢ. In an embodiment, the per-channel scaling may, e.g., be obtained with

$${c}_{i} = 1 - d ( {p}_{0} , {p}_{i} ) . \qquad ( 7 )$$

(The larger the distance between p₀ and pᵢ, the smaller cᵢ.)

In an embodiment, if needed, the scaling value may, e.g., be adjusted further to limit the dynamic range of the location-based scaling. For example, without further scaling and applied on decibel-domain values, there would be no ducking at all on the loudspeaker behind the listener (assuming front-center foreground). This may also be aesthetically undesirable. The limitation of the distance value between the two values rₗₒ and rₕᵢ can be done, e.g., with

$${c}_{i , lim} ( {p}_{1} , {p}_{2} ) = {r}_{lo} + {c}_{i} ( {r}_{hi} - {r}_{lo} ) . \qquad ( 8 )$$

with rᵢₒ=0.3 and rₕᵢ=1, for example. lim stands for limited, or scaled, meaning “further scaled cᵢ”.

The range defines how much scaling we apply to the ducking. With a range of 0-1 we apply the full scaling. With a range of 0.5-1 we apply half of the scaling. The definition where the difference between rₗₒ and rₕᵢ is located in the 0-1 range is not too relevant because it is a multiplicative coefficient applied to the individual i scaling. The second phase process is more relevant.

For real-world applications, it may, e.g., be assumed that the dominant foreground sound is a point source at a fixed location, for example, matching the front-middle-center channel (azimuth=0, elevation=0). In the following, the unlimited cᵢ and limited scaling values c_{i,lim} are used interchangeably. All embodiments described with reference to cᵢ may, e.g., equally be implemented using c_{i,lim} instead of cᵢ and vice versa.

Alternatively to the above-described embodiments, in other embodiments the per-channel scaling cᵢ may, e.g., be defined manually.

By this, the problem of the holes in the acoustic scene in locations away from the foreground sound, may, e.g., be addressed further.

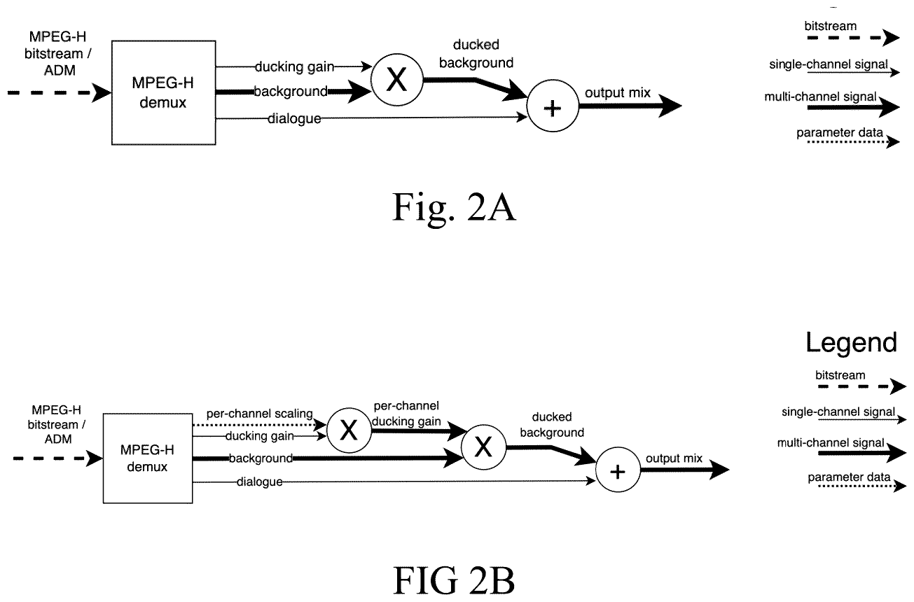

FIG. 2a illustrates an apparatus, where a single ducking gain is applied equally on all channels of the background signal for obtaining the ducked background. This results into the perceptual holes in the audio scene the farer it is in regard to the foreground signal position.

FIG. 2b illustrates an apparatus according to an embodiment, where per-channel scaling values are applied on a single ducking gain.

In an embodiment, these scaling values may, e.g., be transported within a bitstream.

In another embodiment, these scaling values may, e.g., be provided externally.

Applying the per-channel scaling results in per-channel ducking gains that are then applied on the background signal for obtaining a spatially-scaled ducking on the background signal, which solves the perceptual hole problem.

That FIG. 2a and FIG. 2b refer to an MPEG-H demux (demultiplexer) is to be understood as a non-limiting example, only. Other embodiments relate to other demultiplexers not related to MPEG-H. Further embodiments do not employ a demultiplexer at all.

The scaling of the ducking gain depending on the spatial location of the reproduction channel location solves the issue of acoustic scene holes. At the same time, it introduces a new problem. The amount of overall ducking in the background signal energy is changed from the original version (in which all channels were ducked equally). For example, with the setting rₗₒ<1, rₕᵢ=1, the result has in general less ducking than in the original case. Even though the spatial separation between the back- and foreground may alleviate this issue to some degree, the overall mixture would still possibly have too small amount of ducking, e.g., the background signal may, e.g., be too loud when the foreground is active.

In some embodiments, a signal and/or layout-dependent additional global scaling s may, e.g., be applied on the per-channel ducking gains scaling values:

$${\hat{c}}_{i} = s {c}_{i} . \qquad ( 9 )$$

ĉ (“c hat”) indicates a modified value of c In an embodiment, the value s may, e.g., be channel-independent. s may, e.g., be a global value applied to each per-channel value for each i.

To determine value s, the per-channel background signal level is assumed to be eᵢd(t). In particular, eᵢ(t) may, e.g., be assumed to indicate the energy value of the channel i at instant t.

In an embodiment, eᵢ(t) may, e.g., be the real signal energy level. For example, eᵢ(t) may, e.g., be a measured signal energy level of channel i. Or, for example, in another embodiment, eᵢ(t) may, e.g., be an estimated signal energy level of channel i.

In a further embodiment, eᵢ(t) may, e.g., be a symbolic weighting value. Using a symbolic weighting value may, e.g., be done such that that, e.g., instead of measuring the punctual energy of i, a constant weighting coefficient may, e.g., be assigned to channel i.

The total ducked (using the reference ducking value equal in all channels) background signal energy at time instant t is now

$${e}_{ref} ( t ) = {\sum }_{i} {e}_{i} ( t ) {10}^{g ( t ) / 10} . \qquad ( 10 )$$

The total background energy after ducking with the globally-scaled per-channel values is then

$${e}_{scaled} ( t ) = {\sum }_{i} {e}_{i} ( t ) {10}^{{sc}_{i} {g}_{i} ( t ) / 10} . \qquad ( 11 )$$

It is now intended that the two energies in Equations (10) and (11) are equal, because the overall ducking applied to a multichannel layout using the scaling is aimed to be equal to the ducking applied to without scaling.

That the overall energy of the two ways of ducking the background signal is aimed to be equal may, e.g., be expressed as:

$${e}_{ref} ( t ) == {e}_{scaled} ( t ) . \qquad ( 12 )$$

In other embodiments, it may, e.g., not be necessary that e_{ref}(t)==e_{scaled}(t) is fulfilled.

For example, a factor may, e.g., be applied on the reference energy e_{ref}(t), for example, as:

$$p \cdot {e}_{ref} ( t ) == {e}_{scaled} ( t ) . \qquad ( 12 a )$$

with p being, for example, a real number different from 0.

With respect to e_{ref}(t)==e_{scaled}(t) as defined in equation (12), unfortunately, it is not possible to fulfil (in other words: to solve) this equality requirement with non-trivial energies and a wider range of ducking gain values. However, the equality requirement can be reformulated into a form of a loss function, for example,

$$l ( s ) = {\sum }_{t = 1}^{T} {\vert \frac{{e}_{ref} ( t )}{{e}_{scaled} ( t )} - 1 \vert}^{a} . \qquad ( 13 )$$

In one embodiment where a=2, equation (13) results in (14)

$$l ( s ) = {\sum }_{t = 1}^{T} {( \frac{{e}_{ref} ( t )}{{e}_{scaled} ( t )} - 1 )}^{a} . \qquad ( 14 )$$

The loss function of (13) indicates the deviation between e_{ref} and e_{scaled}.

Or, if a factor is applied on the reference energy e_{ref}(t) in accordance with equation (12a), equation (13) becomes:

$$l ( s ) = {\sum }_{t = 1}^{T} {\vert \frac{p \cdot {e}_{ref} ( t )}{{e}_{scaled} ( t )} - 1 \vert}^{a} . \qquad ( 13 a )$$

In general, equation (12a) is equal to equation (12) and equation (13a) is equal to equation (13), if p=1.

In particular, the loss function minimizes the squared deviation of the resulting total energy between the reference background level and modified background level over all time instants. In other embodiments, other forms of loss functions may, e.g., be employed. Further embodiments do not employ a loss function, but solve equality requirement (12) or requirement (12a) in a different way.

In an embodiment, finding the scaling s that minimizes l(s) for the given layout, energies, initial per-channel scaling values and ducking gains, may, e.g., be conducted by solving the equation analytically.

In another embodiment, however, finding the scaling s may, e.g., be conducted by initializing the global scaling with sᵢₙᵢₜ=1 and by then performing a numerical search, for example, with gradient descent for minimizing the defined loss function.

In a further embodiment, a grid search over an expected range of scaling values may, e.g., be performed. For example, when the initial scaling only reduces the ducking depth, a plausible search range is 1 . . . 2, and the selected solution is the parameter value providing the minimal loss.

If the final reproduction layout is different from the transport layout, format conversion weights m_{j,i} may, e.g., be included, e.g., defining the (passive) mixing weight from the transport layout channel i to the reproduction layout channel j. This additional weighting may, e.g., be included in the estimate of the resulting ducked energy with

$${e}_{scaled} ( t ) = {\sum }_{j} {\sum }_{i} {m}_{j , i} {e}_{i} ( t ) {10}^{{sc}_{i} {g}_{i} ( t ) / 10} . \qquad ( 15 )$$

In the embodiment above, the scaling may, e.g., be computed for each content as it depends on the integrated energy of the signal. In embodiments described in the following, the approach may, e.g., be simplified by introducing a constant energy.

Embodiments rely on per-channel energy eᵢ(t) and per-channel ducking gain gᵢ(t). These both are signal-dependent and time-varying. In practice, this means that the global scaling factor would be computed for each content item. As a result, the scaling is guaranteed to be optimal for the specific item and the ducking gains for which it has been computed. A potential drawback is that the optimization needs to be performed for each item and this introduces computational complexity.

In the following, embodiments are described that increase efficiency by simplification.

According to an embodiment, as a first simplifying assumption, it may, e.g., be assumed that the per-channel energy is not time-varying, but may, e.g., instead be assumed to be a channel-dependent constant, i.e., eᵢ(t)=eᵢ. This value may, e.g., be the mean signal energy of the item, or a weighting factor depending on the channel's spatial location, or similar.

In an embodiment, it may, e.g., even be assumed that the per-channel energies are all equal, i.e., eᵢ(t)=w, where w is a constant, e.g., w=1.

According to an embodiment, instead of using the real, time-varying ducking gain g(t) in the computation, a range of “interesting” ducking gain values may, e.g., be defined, for which the scaling should work, and the optimization is done only for these values. For example, each per-channel energy value may, e.g., be multiplied with each possible gain value, and/or optimizing over all these combinations may, e.g., be conducted. In an embodiment, such an approach may, e.g., be employed, and the ducking gain may, e.g., be assumed to be, for example, within the range −20≤g(t)≤0 with, for example, 100 linearly-spaced values in-between.

In an embodiment, the time-invariant per-channel energy and manually-defined ducking gain range may, e.g., be combined to allow removing the variable corresponding to time from the optimization. The optimization may, for example, be conducted considering only all possible ducking gain values for the constant per-channel energies. This leads to a significantly smaller number of values to consider in the optimization task compared to using the full freedom.

Even though these simplifications introduce some level of numerical inaccuracy to the overall scaling value, the real-world effect is negligible, and significant efficiency advantages can be achieved.

In some embodiments, further efficiency advantages may, e.g., be achieved by the possible quantization of the scaling values for the transport.

For example, for application in MPEG-D and MPEG-H, in some embodiments, the per-channel scaling values ĉᵢ may, e.g., be quantized, for example, for storing or transporting them in a bitstream. For example, practically, a quantization step size of 0.125 may, for example, be used. One can ignore this in the optimization and only quantize the values produced by the proposed algorithm. An alternative may, e.g., be to include the knowledge of the quantization already in the optimization task, for example by modifying Equation (11) to

$${e}_{scaled} ( t ) = {\sum }_{i} {e}_{i} ( t ) {10}^{quant ( {sc}_{i} ) {g}_{i} ( t ) / 10} , \qquad ( 16 )$$

where quant(x) is a function quantizing the given argument.

The quantization may, e.g., create regions where a small change in the parameter s does not result in a change in the loss function. This may cause problems in certain optimization algorithms, e.g., one relying on gradient descent. Some other embodiments employ some other optimization methods, such as grid search, which are robust against these effects.

Summarizing some of the above-described embodiments, some embodiments provide a solution for adapting a single background ducking gain for individual channels of an immersive playback layout, such that the resulting ducking avoids the perceptual hole of excessive or unnecessary ducking in channels that are far away from the location of the foreground signal.

Particular embodiments determine a per-channel scaling value depending on the spatial distance from the assumed foreground location, and/or apply a global scaling applied on top of the per-channel scaling values accomplishing an overall ducking depth comparable to the case where a single global ducking gain is applied.

The result of the proposed concepts may, e.g., be parameterized as a list of per-channel gain scaling values that are multiplied on the global ducking gain when applying the per-channel ducking. This allows highly efficient transport of the per-channel ducking gains in the form of a single scalar per channel in addition to the global ducking gain while accomplishing aesthetically more pleasing ducking in immersive playback scenarios.

In the following, further embodiments are described.

According to an embodiment, a method for loudspeaker layout optimized mixing of a primary audio signal (e.g., dialogue, foreground) and a secondary audio signal (e.g., background) is provided.

The term “loudspeaker layout” may, e.g., be understood as a geometrical/spatial positioning of one or more loudspeakers used for the reproduction of the signal. If the loudspeaker layout has only a single loudspeaker, it will reproduce both the foreground and the background signals in it and the full ducking, regardless of the spatial location.

Some embodiments are employed for automatic audio mixing processors, encoders, and/or decoders, and/or for dynamics audio processors (hardware or software, plug-ins or stand-alone), and/or for manually operated audio mixing equipment (mixing consoles, audio routers).

According to an embodiment, a concept for loudspeaker layout optimized mixing of a primary audio signal and a secondary audio signal is based on a ducking gain signal specifying the attenuation (and/or amplification) to be applied on the secondary signal.

In an embodiment, the concept for loudspeaker layout optimized mixing may, e.g., be determined based on the content, level, or other properties of the secondary and/or primary audio signals. In another embodiment, the concept for loudspeaker layout optimized mixing may, e.g., be artistically designed.

According to an embodiment, the mixing of the primary and secondary signals may, e.g., be optimized for the specific reproduction loudspeaker layout.

In an embodiment, the optimization may, e.g., be conducted based on the spatial physical or virtual locations of the one or more loudspeakers in the layout.

According to an embodiment, the ducking gain applied on the channels of the secondary signal may, e.g., depends on a scaling factor.

In an embodiment, the scaling factor may, e.g., depend on a spatial physical or virtual location of the secondary signal's loudspeaker(s).

According to an embodiment, the scaling factor may, e.g., depend on the distance between the secondary signal(s) loudspeaker location(s) and the location of a reference point (e.g. the primary audio signal loudspeaker location).

In an embodiment, the distance may, e.g., be measured, for example, using an angle between the loudspeaker and the location of the primary audio source.

According to an embodiment, a global scaling term may, e.g., be employed accounting for overall ducking depth.

In an embodiment, the scaling factor may, e.g., reduce the magnitude of the modification applied on the secondary audio signal channel when its loudspeaker location has a larger distance from the location of the reference point (for example, from the location of the primary audio source).

According to an embodiment, the ducking applied on a specific channel of the secondary signal may, e.g., depend on the common ducking gain signal and a per-channel scaling value.

In an embodiment, the per-channel scaling value may, e.g., be determined based on the spatial physical or virtual location of the secondary signal loudspeaker, or a distance between the reference point (for example the primary audio signal loudspeaker physical or virtual location) and the physical or virtual location of the channel of the secondary audio signal loudspeaker.

According to an embodiment, the global scaling term may, e.g., be determined such that the total (instantaneous) energy of the secondary audio signal after applying the per-channel scaling is approximately equal to, or proportional to, the total (instantaneous) energy of the secondary audio signal when only the global mixing gain is applied. For example, this is possibly depending on the level/energy of the secondary signal in each channel. The global scaling term may, for example, be time-varying, and/or may, e.g., depending on the ducking gain that may vary over time.

In an embodiment, the computed per-channel scaling values may, e.g., be transported as additional side information.

According to an embodiment, it may, e.g., be possible that the computation of the per-channel scaling values is done at the decoder/rendering, when the output loudspeaker layout is known (e.g., instead of using the transport layout).

In an embodiment, the computation may, e.g., take the audio channel format conversion into account taking place during the reproduction when the transport channel layout is different than the actual reproduction channel layout.

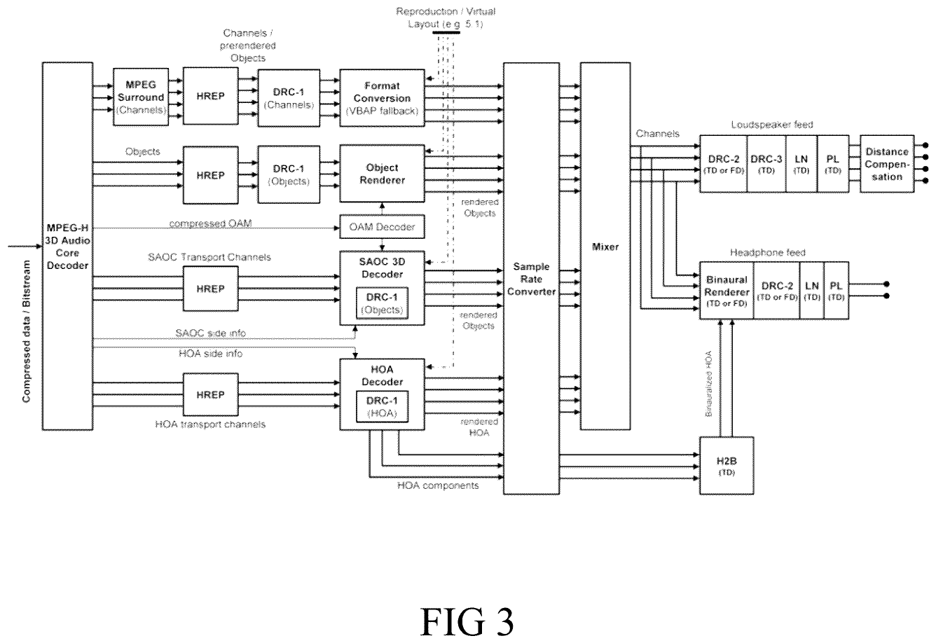

According to an embodiment, the gain is applied in an MPEG-H system. FIG. 3 illustrates a block diagram of an MPEG-H 3D-Audio decoder according to an embodiment. Such an embodiment aims to author an MPEG-H Audio Scene. In the block diagram of FIG. 3, the MPEG-H audio decoder operations are depicted.

The ducking may, e.g., be applied as “DRC-1”. This means that it may, e.g., be applied on the full object representation before format conversion. For example, for a 22.2 bed and mono dialogue to be played back on a 5.1 system, the ducking gains may, e.g., be applied on the 22.2 bed signal, this is downmixed to 5.1, and then mixed with the dialogue object. The net effect from this is that at the moment the ducking is applied, there is no information available from the reproduction layout and the ducking is the same.

In the following, development and testing of particular embodiments is described.

A series of listening tests have been conducted for gathering evidence on which method, configurations and settings are particularly suitable for applying scaled gain sequences to multichannel Bed and for developing and proving the effectiveness of the proposed solutions.

Main goals of these investigations have been to study spatial sound perception with focus on multichannel background ducking, to define minimum and optimal channels grouping for applying scaled ducking, to specify parameters for multichannel background ducking aiming at pleasing and balanced spatial scene, to define scaling weighting values, and to possibly avoid dynamic gains in order to spare bitrate/complexity.

The investigations have been based on the non-limiting, exemplary assumptions that foreground components are mono and reproduced from the center speaker only, and that channel grouping is executed along the frontal axis, either on the horizontal or the vertical plane, in order to maintain the Left/Right and Top/Bottom balance unchanged.

Preliminary testing has been conducted. The testing design described below is based on the findings from this preliminary testing. The preliminary testing has comprised listening to a selection of candidate content in various layout formats with the goal to identify the material which would have supported best the investigation and to have a preliminary understanding of the problem and on the possible solution.

The results from the preliminary testing have indicated that there was no benefit in using both a male and a female voice for each item. It was then decided to keep only test content with male voice as it covered a larger spectrum and had more pauses during the speech recording (pauses in speech content help the assessment of the ducking quality). Moreover, the results have indicated that the Top-Front channels seem to not require much ducking as the distance to the Center channel where the foreground is reproduced is providing significant separation (“cocktail party” effect), and that the perception of the isolated channels groups is well correlated with the perception obtained when all channels are concurrently active. The preliminary testing has substantially confirmed the validity of the approach in being capable of driving towards the meaningful tuning.

A selection of program excerpts representing typical broadcast content has been used for the investigation as source test items. In addition, a custom-made immersive decorrelated noise signal has been employed.

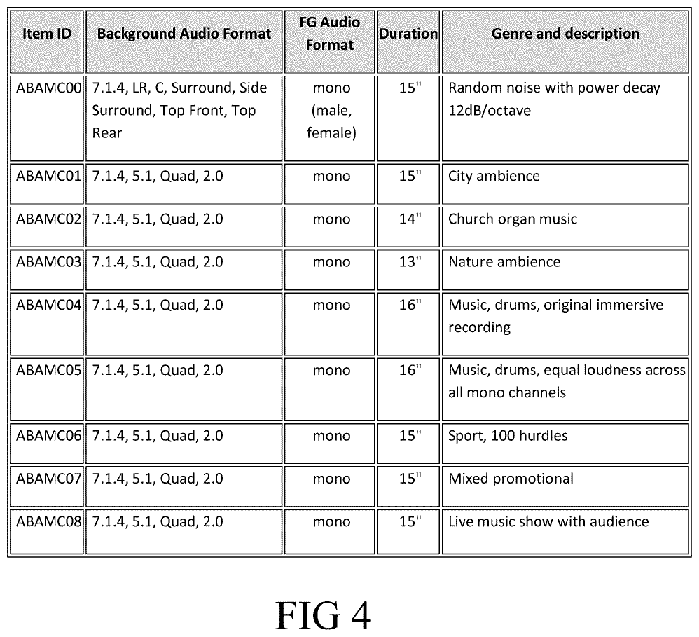

FIG. 4 illustrates a table comprising a plurality of different source test items of a listening test.

In the following, a listening test (listening test, part A), defining channels grouping is described in detail. A goal of this listening test has been to defined minimum and optimal channels grouping for applying scaled ducking. The source test item ABAMC00 has been used in all available background formats. The multichannel Bed has been split into five groups. Both foreground and background have been normalized to the same Programme Loudness level (−27 LUFS on ITU-R.BS1770 scale). The configuration with the finest grouping resolution has been used. The listening test has been executed requesting the listeners (sound experts only) to assess for each condition the intelligibility of the foreground (FG) signal and overall pleasantness of the mix (assessment with MUSHRA scale with labels).

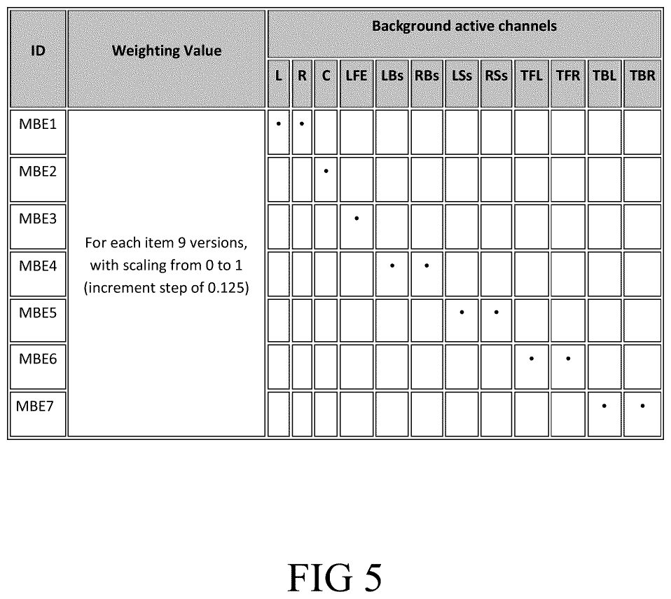

FIG. 5 illustrates a table which illustrates a different weighting that has been applied to the channel groups during a listening test. 1 denotes that ducking has been applied, 0 denotes that no ducking has been applied. The listening test has been aimed to show the impact of each of the 5 groups (Front, Center, Rear, top Front, top Right), has been aimed to identify the more meaningful configurations, and has been aimed to reduce the number of groups by combining e.g. Front+Center or top Front+top Right.

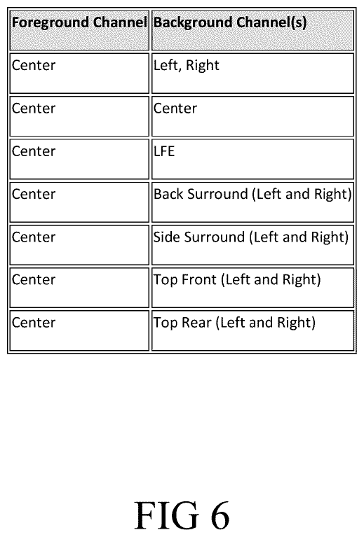

In the listening test, the subject has been presented with seven control screens, wherein each page included nine conditions. Each condition consisted of an automatic generated mix of foreground sound (German speech, male) and background sound (random noise, power slope −12 dB/oct). While the foreground sound has been reproduced by the Center speaker, the background sound has been reproduced by one or two symmetric loudspeakers only, depending on the control screen being displayed. The seven control screenshave been randomly displayed and have included the loudspeakers combinations illustrated by the table depicted by FIG. 6.

The nine conditions differ by what ducking scaling factor was applied. The first condition had a factor of 0 (no ducking). The last condition had a factor of 1 (maximum ducking). From the 2^{nd} to the 8^{th} condition, gradually increasing factors were applied (0.125, 0.250, 0.375, 0.500, 0.625, 0.750, 0.875).

As guidelines for the first listening test (listening test, part A), the subjects were asked to assess the quality of the overall sound mix with a score from 0 to 100 (from bad to excellent) based on what appears to be a correct and appropriate balance between foreground and background. They were asked to not consider the time constants used for generating the automatic mix. The subjects were also provided with the following guidelines: “The clearer the speech is (no unnatural, annoying noise ducking masking the speech) the higher the score. If the speech does not result easily audible because of a too loud noise, the score should reflect this and tend to be low. However, if the speech sounds clear, but the level changes in the noise are too emphasized and easy to be perceived (because not masked by the speech) the score should be low. The highest score should mark the best balance between foreground and background, and indicate that the level variations in the noise are not significantly noticeable or annoying.”

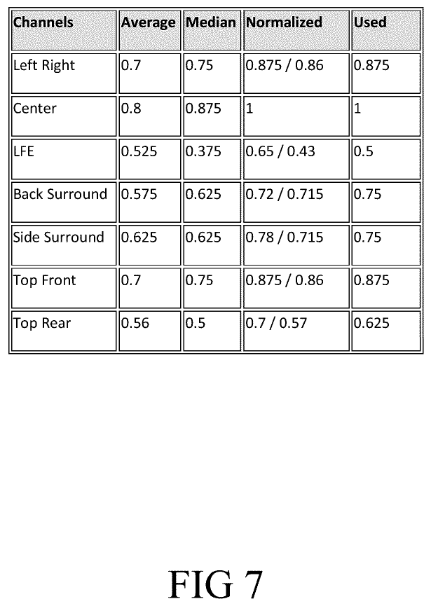

FIG. 7 illustrates a table showing the results of the listening test, part A.

In the following, a listening test (listening test, part B) is presented which defines an optimal scaling weighting per each channels group of 7.1.4 Bed. A goal of this listening test has been to determine an optimal weighting per each group resulting from the listening test, part A (7.1.4 only).

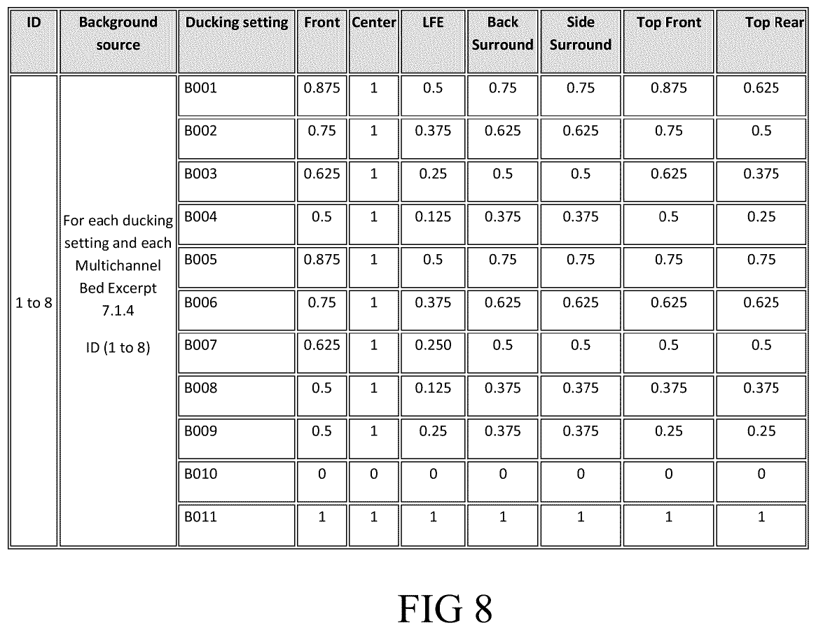

As the applied method, the configuration(s) that have produced the highest score from listening test A have been selected. Test items from 01 to 08 have been used, and various settings for scaling weighting to the selected configuration have been used as indicated in the table of FIG. 8. The listening test has been executed requesting the listener (sound experts only) to assess the intelligibility of the foreground signal and overall pleasantness of the mix (assessment with a MUSHRA scale with labels).

FIG. 8 illustrates a table which illustrates a different weighting that has been applied to the channel groups during the listening test, part B.

As expected result, an indication on an optimal scaling weighting for each channels group resulting from the listening test, part A, was expected.

In the listening test, part B, twelve control screens displaying real program excerpts have been presented to the subjects. Each control screen included eleven conditions. Each condition consisted of an automatic generated mix of a foreground signal (speech), reproduced by the Center speaker, and a background signal (7.1.4 immersive bed), reproduced by all loudspeakers. The eleven conditions differed by how the scaling gains were applied. Specifically, nine out of the eleven conditions applied the same overall amount of ducking, although with differences in how the ducking is distributed across the immersive layout (different per-channel gain). The remaining two conditions applied extreme settings and were presented for verification purposes.

As guidelines for the second listening test (listening test, part B), the subjects were asked to assess the quality of the overall sound mix with a score from 0 to 100 (from bad to excellent) based on what appears to be a correct and appropriate balance between foreground and background components. It was advised to not consider the time constants used for generating the automatic mix and to just focus on how the individual channels of the background component were ducked. The subjects were also provided with the following guidelines. “The more balanced, pleasant and smooth the background attenuation results with special regard to how the individual channels of the 7.1.4 Bed are ducked, the higher the score. If the background attenuation is uncomfortably noticeable, e.g. some channels are annoyingly more ducked than others, the lower the score. Feel free to assign the same score to more than one condition, if that is how you rate them. Because of the duration of the overall listening test, it might be needed to stop the session after the first 6 or 7 control screens, to take a break, and to complete the assessment once you feel good to continue, either in the same day or in a new one.”

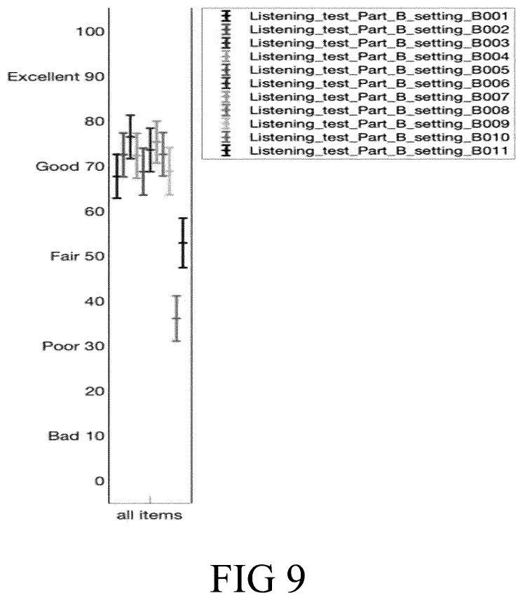

FIG. 9 illustrates the results of the second listening test, multichannel Bed part B. The average and 95% confidence intervals for 10 listeners is depicted. As displayed in the plot in FIG. 9, the second listening test (listening test, part B) has provided two very important results, namely that it has been clearly confirmed that it is useful to scale the ducking gain on a per-channel basis, and that the difference between different per-channel settings is small.

In the following, testing the proposed algorithm for computing scaled spatial ducking is described. After having performed the first, second and third listening tests further aspects have been considered. It was envisioned to extend the ducking method to include layouts up to a 22.2 and for any loudspeaker's position.

Because of the increasing number of possible configurations, at that point it has been decided to approach the problem with a more flexible method which would specifically take into account the exact localization of the discrete per-channel background sound source.

Specifically, two different methods have been considered, namely “great-circle weighting” and “egg weighting”, which are described in the following.

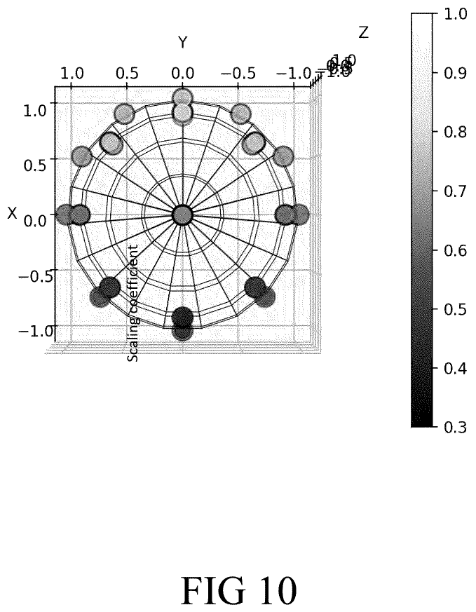

At first, “great-circle” weighting is described. FIG. 10 illustrates a loudspeaker layout and gains for a particular computation example for great-circle weighting. The points on the X and Y axis are the cartesian coordinates for the horizontal plane, where

$$X > 0 -> Front , X < 0 -> Rear$$

$$Y > 0 -> Left , Y < 0 -> Right$$

The Z axis indicates Elevation of loudspeakers on the vertical plane.

According to the concept of FIG. 10, the great-circle distance between the loudspeaker and the assumed dialogue location (C000) is computed. The distance can be simplified into the 3D spatial angle between the two vectors corresponding to the dialogue location and the loudspeaker location. The distance or angle has then been normalized to the specified scaling range, here to 0.3-1.0. A distinct property of the great-circle weighting is that the further away from the dialogue location the loudspeaker is, the less it is ducked. The main drawback of the “great-circle” weighting is that it does not consider the receiver property that the ears are pointing to +−90 degree, and the three spatial axes have a different relevance for the perception.

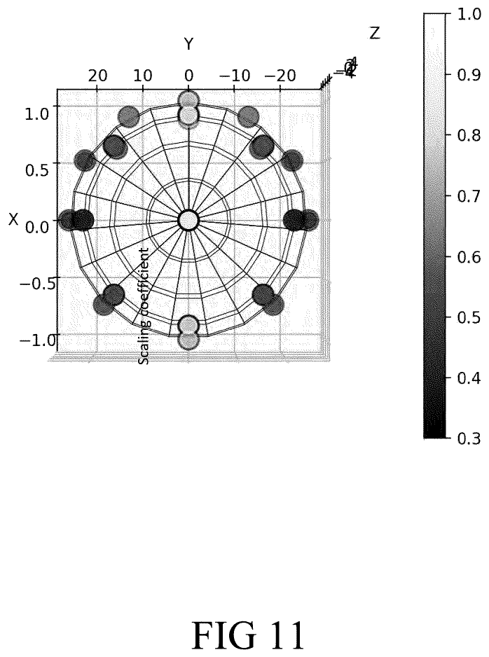

Now, “egg” weighting is described. FIG. 11 illustrates a loudspeaker layout and gains for a particular computation example for egg weighting.

The points on the X and Y axis are the cartesian coordinates for the horizontal plane, where

$$X > 0 -> Front , X < 0 -> Rear$$

$$Y > 0 -> Left , Y < 0 -> Right$$

The Z axis indicates Elevation of loudspeakers on the vertical plane.

Subjective measurements on spatial masking along the horizontal circle suggest that the sound source directly behind the listener is getting masked almost as strongly as when it was at the same location as the masker. There are complex data-driven models for this, but a simplification is to distort the unit sphere comprising the loudspeakers so that it is stretched quite some amount on the left-right axis, and stretched a smaller amount on the top-bottom axis. The purpose of this is to very coarsely weight the importance of the three spatial axes. The weighting has been computed by computing the Euclidean distance (e.g., line distance) between each loudspeaker and the dialogue location, and mapping this to the range 0.3-1.0. The resulting scaling would apply almost the full ducking depth on the signals from loudspeakers behind the listener, and the least ducking on the signals from loudspeakers directly to left/right of the listener. This weighting may model spatial masking and are particularly suitable if the listeners do not move their heads. Because of the front/back confusion, the signals from the rear loudspeakers shall be ducked significantly. However, if the listeners may move their heads, the front/back confusion is solved, and it is possible that the result is perceived as excessive ducking in the back loudspeakers.

In the following, initial testing is described which has been conducted for determining the method.

For both the great-circle and the egg configurations, items were produced with two automatic ducking settings.

Both methods have been tested in individual listening sessions. Comparing great-circle versus egg configurations, in general, the background is louder during ducking for the egg method. This may be a perceptual issue or this may be an issue that can be measured and compensated for. A compensation would make the comparison between the methods more reliable. When staying stationary and looking towards C, the two approaches sound surprisingly similar (except for the overall background level difference). When moving the head, the great-circle method has a more complete sound scene in the rear: there is no unnecessary ducking. The ducking in the rear could be even less, and the difference and/or preference is stronger the denser the scene in the rear is. To some extent, and especially if not turning the head, the two configurations are similar. Yet, some relevant differences exist. In general, great-circle ducking seems to be attenuating even more than egg ducking on the front channels, what is not so comfortable. Rear and/or immersive attenuation of the egg method is not necessary and would results in an uncomfortable lacking of energy in the sound field. With the egg method, at ducking events, an unwanted move of the sound center of gravity towards the front occurs. For the great-circle method, this does not occur, or at least is much less noticeable. The above effects are more noticeable when turning the head 90°. Content seem to play noticeable role in how the ducking performs, regardless of the used configuration. The overall perception is somehow content-dependent.

Regarding optimized coefficients for Great-Circle scaling, once it has been found that the great-circle method was solving the first problem of calculating per-channel scaling, this solution has been improved even further in a way to achieve a distributed ducking independently from the background layout and the reproduction layout.

The following listening test has then been designed and executed to validate this idea, wherein downmixed-stereo ducking has been compared versus native-stereo ducking. The goal was to verify the per-channels coefficient and find the value that works statistically best.

As test design, stereo downmixes of the 22.2 bed signals (uncorrelated pink-noise) have been created and stereo mix programmes have been processed with an automatic ducking tool.

As stereo downmix programmes, the resulting mixed 22.2 signal have been downmixed. The stereo mix programmes have been compared to the stereo downmix programmes. The per-channel setting has been modified until the stereo mix and the stereo downmix programmes sounded similar, making the assumption that the energies are the same (the steps of this paragraph).

Several scaling settings have been tested. Their goal was to produce a downmixed ducked mix which would aesthetically sound as close as possible to the native stereo ducked mix. To obtain the results of downmixing test, a criteria has been applied, wherein the criteria was to evaluate the difference was by summing a phase reversed downmixed ducked mix to the native stereo ducked mix. Only the region where the ducking was fully active were considered. The smallest the resulting sum was, the closer the two versions were.

Resulting from the test, it has been noted that the downmixing generates additional overall energy to the background channels. This becomes evident in the non-ducked parts where the downmixed signals are often much louder than the equivalent native stereo. When ducking is not active and the level is changing, then the issue is outside of ducking scaling.

In the following, further considerations of the tests are discussed. It has been noted that an automatic ducking tool computes a ducking that defines how much energy we need to suppress from the background signal. This would be acceptable from an energy point, if all channels are ducked equally, and, e.g., all channels comprise equal energy. Because equally ducking all channels sounds annoying, we want to redistribute the ducking. Gain scaling may, e.g., be employed to reduce ducking, e.g., at the rear. Through the scaling, some overall ducking may, e.g., be lost, and the remaining energy may, e.g., remain too high.

To find a global scaling to be applied on the modified ducking gains such that the total amount of ducking is again the same as before the per-channel scaling, is not possible according to the numerical test executed via a simple equation in Python. A major problem in the numerical example was that the accuracy of the compensation was dependent on the value of the ducking gain. The deeper the ducking is, the larger the overall scaling coefficient needs to be that the effect on the overall energy on per-channel scaled ducking is the same as in equal-ducking-per-channel case. It has been noted that there is a conceptual problem in applying a global scaling on all ducking gain values: The scaling operates as a multiplier and the output depends from the original ducking gain. Smaller gains are modified less than larger (negative) ducking gains. This means that the scaling of the ducking gain cannot replace a proper setting of clearance.

As a solution of that problem, based on the observation that a single global compensation scaling cannot provide accurate energy-level compensation for different ducking gain values, an approximation approach is provided. The core idea is that after applying the global compensation scaling, the errors should somehow be evenly distributed over the possible ducking gain range. The definition of “evenly” is a design parameter, but a reasonable alternative is to expect that the total loudspeaker energy after applying the global compensation should be the same as without any per-channel scaling applied. This can be used as a loss function for a model that has a single parameter, namely the global compensation scaling value

This optimization task may, e.g., be solved analytically, but an easier approach would be to use numerical optimization. As the value will be greater 1, and is one-dimensional, a line search probably may, e.g., be sufficient. The first implementation now uses gradient descent.

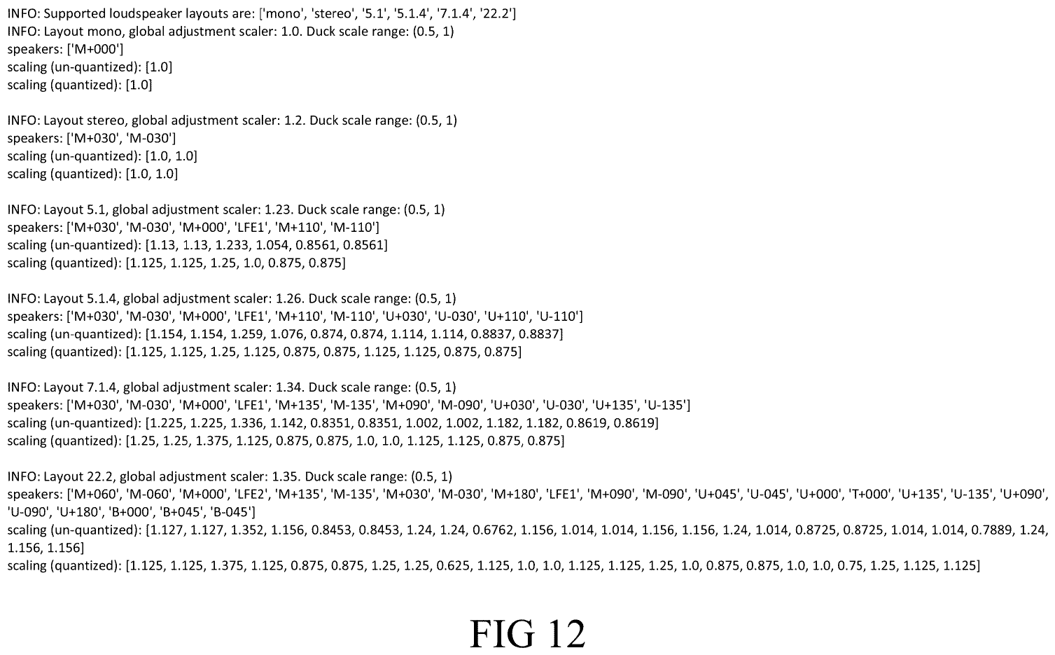

In the following, examples for scaling coefficients are provided. For several layouts up to 22.2, great-circle scaling, and an initial scaling range of 0.5 . . . 1, the energy-preserving algorithm provides the per-channel ducking gain scaling values (for the ducking gain range of −20 . . . 0 dB) illustrated in FIG. 12.

A final testing according to a particular embodiment is now described. In order to evaluate the subjective performance of the provided algorithm and the effect of downmixing occurring in the end-user device, the following listening test has been designed and executed.
1. For each 22.2 native content, produce downmix versions for each of the selected layout (mono, stereo, 5.1, 7.1.4).
2. Normalize them to the same loudness level of −24LUFS. 3. For each native content, select a background layout form the list of the selected ones (mono, stereo, 5.1, 7.1.4, 22.2).
4. Select one range from the list of the selected ones (0.3 . . . 1, 0.5 . . . 1).
5. Apply the corresponding optimized gain coefficients and produce a ducked mix test item.
6. Repeat steps 3, 4 and 5 until all combinations are produced.
7. For each native content, and for range 0.3 . . . 1, listen to the every layout ducked mix.
8. Comment on the quality of the ducking in terms of dialogue intelligibility, pleasantness and consistency across layouts.
9. Repeat step 7 an 8 for range 0.5 . . . 1.
10. Annotate conclusions.
11. For each of the 22.2 “mix ducked” content, generate the downmixed versions of 7.1.4, 5.1, stereo and mono (called post-ducking downmix).
12. For each layout, compare each of these downmixed programs with the “mix ducked” content produced with the downmixed background (called pre-ducking downmix).
13. Comment and annotate on the consistency between the two versions (11. post-ducking downmix 12. pre-ducking downmix) The following results of the final listening test have been noted: The overall quality is good.

The algorithm performs as expected and allows for layout-agnostic unassisted automatic mixing. All versions sound very intelligible. It is hard to find the advantageous range setting, although the range 0.3-1 seems to result in a more pleasant distribution of the ducking in the immersive soundfield. The listening experience result substantially consistent across all layouts. The pre- and the post-ducking downmix versions work equally well in the parts where the ducking is active (the foreground signal is present). However, the pre-ducking downmix result in a better overall experience because of the loudness alignment applied to the already downmixed background component. Nevertheless, post-ducking downmix is totally intelligible.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer or an electronic circuit. In some embodiments, one or more of the most important method steps may be executed by such an apparatus.

Depending on certain implementation requirements, embodiments of the invention can be implemented in hardware or in software or at least partially in hardware or at least partially in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitory.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

The apparatus described herein may be implemented using a hardware apparatus, or using a computer, or using a combination of a hardware apparatus and a computer.

The methods described herein may be performed using a hardware apparatus, or using a computer, or using a combination of a hardware apparatus and a computer.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. An apparatus for generating one or more audio output channels from one or more audio signals, wherein the apparatus comprises:
a gain determiner configured to generate or to receive gain information, wherein the gain information indicates for each audio signal of at least one audio signal of the one or more audio signals how to attenuate or how to amplify said audio signal depending on a position associated with said audio signal and a reference position, and
a signal generator configured to generate the one or more audio output channels from the one or more audio signals by attenuating or amplifying the at least one audio signal depending on the gain information.

2. An apparatus according to claim 1,
wherein the gain determiner is configured to generate, depending on the position associated with each audio signal of the at least one audio signal and the reference position, the gain information; or
wherein the gain determiner is configured to receive the gain information from another apparatus.

3. An apparatus according to claim 1,
wherein the gain determiner is configured to receive the gain information within a bitstream.

4. An apparatus according to claim 1,
wherein the signal generator is configured to generate the one or more audio output channels by mixing the one or more audio signals after the at least one audio signal of the one or more audio signals have been attenuated or have been amplified; and/or
wherein the gain information is gain modification information, wherein the gain determiner is configured to receive initial gain information, and is configured to generate modified gain information from the initial gain information using the gain modification information, and wherein the signal generator is configured to generate the one or more audio output channels from the one or more audio signals by applying the modified gain information on the at least one audio signal.

5. An apparatus for encoding one or more audio signals within a bitstream, wherein the apparatus comprises:
a gain determiner configured to generate gain information, wherein the gain information indicates for each audio signal of at least one audio signal of the one or more audio signals how to attenuate or how to amplify said audio signal depending on a position associated with said audio signal and a reference position, and
a bitstream generator configured to encode the one or more audio signals within a bitstream, wherein the bitstream generator is configured to generate the bitstream such that the bitstream comprises the gain information.

6. An apparatus for obtaining gain information, comprising:
a user interface comprising an input unit, which enables a user to enter input information, wherein the input information comprises the gain information or wherein the apparatus is configured to derive the gain information from the input information, wherein the gain information indicates for each audio signal of at least one audio signal of one or more audio signals how to attenuate or how to amplify said audio signal depending on a position associated with said audio signal and a reference position.

7. An apparatus according to claim 6,
wherein the apparatus comprises a bitstream generator configured to encode the one or more audio signals within a bitstream, wherein the bitstream generator is configured to generate the bitstream such that the bitstream comprises the gain information; or
wherein the apparatus further comprises a signal generator configured to generate one or more audio output channels from the one or more audio signals by attenuating or amplifying the at least one audio signal depending on the gain information.

8. An apparatus according to claim 1,
wherein the reference position is a physical or a virtual position of a loudspeaker in an environment; and/or
wherein the reference position is associated with an audio signal of the one or more audio signals; and/or
wherein the reference position is an actual replay position or an assumed replay position of a loudspeaker that is to replay an audio signal of the one or more audio signals or that is to replay an audio signal derived from said audio signal, and wherein, for each audio signal of the at least one audio signal, the position associated with said audio signal is an actual replay position or an assumed replay position of a loudspeaker that is to replay said audio signal or that is to replay an audio signal derived from said audio signal.

9. An apparatus according to claim 1,
wherein the gain information indicates for each audio signal of at least one audio signal of the one or more audio signals how to attenuate or how to amplify said audio signal depending on a distance between the position associated with said audio signal and the reference position; and/or
wherein the gain information indicates for at least one of the at least one audio signal that said one of the audio signals shall be attenuated less or shall be amplified more compared to another one of the at least one audio signal, if a first distance between the position associated with said one of the at least one audio signal and the reference position is greater than a second distance between the position associated with said other one of the at least one audio signal and the reference position.

10. An apparatus according to claim 1,
wherein the one or more audio signals are two or more audio signals, and
wherein the at least one audio signal are at least two audio signals.

11. An apparatus according to claim 9,
wherein the one or more audio signals are two or more audio signals,
wherein the at least one audio signal are at least two audio signals,
wherein the gain information individually indicates for each audio signal of the at least two audio signals how to attenuate or how to amplify said audio signal,
wherein the gain information individually indicates for each audio signal of the at least two audio signals how to attenuate or how to amplify said audio signal depending on the position associated with said audio signal and the reference position,
wherein the gain information individually indicates for each audio signal of the at least two audio signals how to attenuate or how to amplify said audio signal depending on the distance between the position associated with said audio signal and the reference position.

12. An apparatus according to claim 1,
wherein the gain determiner is configured to determine the gain information such that the gain information indicates gain information for each audio signal of the at least one audio signal, and such that a sum of an energy of each of the at least one audio signal after attenuation or amplification corresponds or is estimated to correspond to a reference energy or is proportional or is estimated to be proportional to the reference energy.

13. An apparatus according to claim 12,
wherein the gain determiner is configured to determine the gain such that a total energy of the at least one audio signal after attenuation or amplification corresponds or is estimated to correspond to a reference energy or is proportional or is estimated to be proportional to the reference energy by employing a loss function.

14. An apparatus according to claim 13,
wherein the loss function is defined depending on:
$$l ( s ) = {\sum }_{t = T 1}^{T 2} {\vert \frac{p \cdot {e}_{ref} ( t )}{{e}_{scaled} ( t )} - 1 \vert}^{a}$$
wherein l(s) is the loss function, wherein s indicates a real number,
wherein p indicates a real number being different from 0,
wherein t indicates a time index being time index T1 or being time index T2 or being a time index between T1 and T2,
wherein e_{ref}(t) indicates the total energy,
wherein e_{ref}(t) indicates the reference energy, and
wherein a indicates a real number.

15. An apparatus according to claim 1,
wherein the gain information indicates for each audio signal of the at least one audio signal how to attenuate or how to amplify said audio signal depending on an angle between the position associated with said audio signal and the reference position.

16. An apparatus according to claim 1,
wherein the gain information comprises a per-channel gain for each of the at least one audio signal,
wherein, to generate the one or more audio output channels, the signal generator is configured to apply, for each one of the one or more audio signals, the per-channel gain for said one of the at least one audio signal on said one of the at least one audio signal.

17. An apparatus according to claim 1,
wherein the position associated with each of the at least one audio signal and the reference position are located on a circle or on an ellipsoid or on a three-dimensional area surrounding the listener.

18. An apparatus according to claim 1,
wherein the gain information indicates for each audio signal of the at least one audio signal how to attenuate or how to amplify said audio signal depending on the position associated with said audio signal and the reference position.

19. An apparatus according to claim 1,
wherein the gain determiner is configured to generate and to quantize the gain information, or
wherein the gain determiner is configured to receive the gain information as quantized information.

20. An apparatus according to claim 1, wherein the apparatus comprises a signal decoder.

21. An apparatus according to claim 1, wherein the apparatus comprises a signal encoder.

22. A method for generating one or more audio output channels from one or more audio signals, wherein the method comprises:
generating or receiving gain information, wherein the gain information indicates for each audio signal of at least one audio signal of the one or more audio signals how to attenuate or how to amplify said audio signal depending on a position associated with said audio signal and a reference position, and
generating the one or more audio output channels from the one or more audio signals by attenuating or amplifying the at least one audio signal depending on the gain information.

23. A method for encoding one or more audio signals within a bitstream, wherein the method comprises:
generating gain information, wherein the gain information indicates for each audio signal of at least one audio signal of the one or more audio signals how to attenuate or how to amplify said audio signal depending on a position associated with said audio signal and a reference position, and
encoding the one or more audio signals within a bitstream, wherein the bitstream is generated such that the bitstream comprises the gain information.

24. A method for obtaining gain information, wherein the method comprises:
receiving input information via an input unit of a user interface, wherein the input information comprises the gain information or wherein the method comprises deriving the gain information from the input information, wherein the gain information indicates for each audio signal of at least one audio signal of the one or more audio signals how to attenuate or how to amplify said audio signal depending on a position associated with said audio signal and a reference position.

25. A non-transitory digital storage medium having a computer program stored thereon to perform the method according to claim 22 when said computer program is run by a computer.

26. A non-transitory digital storage medium having a computer program stored thereon to perform the method according to claim 23 when said computer program is run by a computer.

27. A non-transitory digital storage medium having a computer program stored thereon to perform the method according to claim 24 when said computer program is run by a computer.
